(19) United States
(12) Patent Application Publication
(10) Pub. No.: US 2010/0199286 A1
(43) Pub. Date: Aug. 5, 2010

(54) METHOD AND APPARATUS FOR BUILDING A PROCESS OF ENGINES

(75) Inventors: Qiangze FENG, Beijing (CN); Hongwei Qi, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (CHINA) CO., LTD, Beijing (CN)

(21) Appl. No.: 12/634,185

(22) Filed: Dec. 9, 2009

(30) Foreign Application Priority Data
Feb. 2, 2009 (CN) 200910009755.7

(51) Int. Cl. G06F 9/46

(52) U.S. Cl. 718/106; 707/E17.044

(57) ABSTRACT

The embodiments of the present invention disclose a method and apparatus for building a process of engines. The method can comprise: obtaining a sequence relationship between every two engines based on a historical process of engines; and building a process of engines according to the sequence relationship between every two engines. Automatic engine integration can be implemented by using the method and the apparatus according to the present invention to facilitate user's use.

### FIELD OF THE INVENTION

The present invention generally relates to data processing, and particularly to a method and apparatus for building a process of engines.

### BACKGROUND OF THE INVENTION

Engine integration can link several correlated engines together to build a process, which when executed can solve a specific task. For example, to solve a product extraction task, we can link network information collecting engine, word segmentation engine and product tagging engine together to form a process of engines so as to perform word segmentation on the contents collected via the network and tag information therein related to the product.

The key points of engine integration include engine sequence determination. The US patent publication No. US2004/0243556 A1 describes a system for performing unstructured information management and text analysis, wherein each engine in a process needs to be placed in the predetermined sequence by user, that is, the determination of the engine sequence is not automatic. The US patent publication No. 2005/0097224A1 depicts a method for automatic service composition, by which the sequence of services can be determined by service specifications stored in the service repository, but services without specified service specifications cannot be handled. The Japanese patent publication No. JP10-222371 describes an apparatus for generating and executing a repository system which determines the sequence of engines according to input and output of the engines but cannot handle engines for which no input and output are specified.

As seen from the above, the prior art cannot automatically determine the sequence of engines or the handling scope is limited. Besides, in the prior art whether a process of engines is valid is determined manually rather than automatically.

### SUMMARY OF THE INVENTION

In view of the above problems, an object of the present invention is to provide a technical solution for building a process of engines so as to automatically perform engine integration to obtain a process of engines.

To this end, according to a first aspect, the present invention provides a method for building a process of engines, comprising the steps of: obtaining a sequence relationship between every two engines based on a historical process of engines; and building a process of engines according to the sequence relationship between every two engines.

According to a second aspect, the present invention provides an apparatus for building a process of engines, comprising a process building unit, comprising: means for obtaining a sequence relationship between every two engines based on a historical process of engines; and means for building a process of engines according to the sequence relationship between every two engines.

Other features and advantages of the present invention will be made apparent and obvious by the following depictions of preferred embodiments of the present invention in combination with the accompanying drawings.

### BRIEF DESCRIPTION OF THE ACCOMPANYING DRAWINGS

Other objects and effects of the present invention will be made clearer and comprehensible by the following description in combination with the drawings as well as a fuller understanding of the present invention.

FIG. 1 is a flowchart illustrating a method for building a process of engines according to an embodiment of the present invention;

FIG. 2 is a flowchart illustrating a method for building a process of engines according to another embodiment of the present invention;

FIG. 3 is a flowchart illustrating a method for building a process of engines according to a further embodiment of the present invention;

FIG. 4 is a block diagram of an apparatus for building a process of engines according to an embodiment of the present invention.

In all of the above figures, the same reference number means having identical, similar or corresponding features or functions.

### DETAILED DESCRIPTION OF PREFERRED EMBODIMENT

The embodiments of the present invention will be explained or specified in a more detailed way as follows with reference to the drawings. It should be appreciated that the figures and embodiments of the present invention are only for exemplary illustration purpose not used to limit the scope of protection of the present invention.

For the sake of clarity, all the technical terms in the present invention are first defined as follows:

1. Engine

An engine is a routine for performing a specific management and processing function. For example, a network information collecting engine is a routine for collecting related information from the network; a word segmentation engine is a routine for performing word segmentation on the content collected via the network; and a product tagging engine is a routine for tagging information in the obtained segmented words related to the product.

2. A Process of Engines

A process of engines is an engine sequence built by linking a plurality of related engines together to solve a specific task. For example, a process of engines can be built by linking a network information collecting engine, a word segmentation engine and a product tagging engine to solve a product extraction task. For example, the process can be represented as “network information collecting engine→word segmentation engine→product tagging engine”, wherein the symbol “→” denotes the sequence of two engines. The process indicates first executing the “network information collecting engine”, then the “word segmentation engine” and finally the “product tagging engine”.

3. Sequence Relationship

In the present invention, sequence relationship comprises a sequence between two objects. Alternatively, the sequence relationship further comprises an occurrence frequency of the sequence.

In the present invention, the sequence relationship of every two engines can comprise a sequence between any two of two or more engines, or alternatively comprise an occurrence frequency of the sequence. For example, in the above example, the sequence relationship of the network information collecting engine and the word segmentation engine comprises a sequence of the two engines “network information collecting engine→word segmentation engine”. Alternatively, the sequence relationship of the network information collecting engine and the word segmentation engine further comprises the occurrence frequency of the sequence “network information collecting engine→word segmentation engine” occurred in a historical process.

In the present invention, the sequence relationship of every two engine types comprises a sequence between any two of two or more engine types, and can alternatively comprise an occurrence frequency of the sequence. For example, provided that the type of the network information collecting engine is data reading, and the type of word segmentation engine is data labeling and a historical process including the two engines is “network information collecting engine→word segmentation engine”, the sequence relationship of the two engine types i.e. data reading and data labeling comprises the sequence “data reading→data labeling”. Alternatively, the sequence relationship of data reading and data labeling further comprises the occurrence frequency of the sequence “data reading→data labeling” in the historical process.

4. Historical Process of Engines

A historical process of engines refers to a previously already existing historical process. The historical process of engines can be pre-stored in an engine historical process repository. All the previously established processes can be stored in the engine historical process repository. The engine historical process repository can be implemented in various manners. Table 1 and Table 2 respectively illustrate an example of the engine historical process repository.

TABLE 1
Engine Historical Process Repository

| User name | Historical process of engines | Building time |
|---|---|---|
| User001 | network information collecting | Nov. 5, 2008 |
| | engine→ word segmentation engine | 18:40:36 |
| User002 | database reading engine→ word | Nov. 13, 2008 |
| | segmentation engine → product | 14:10:06 |
| | extraction engine | |

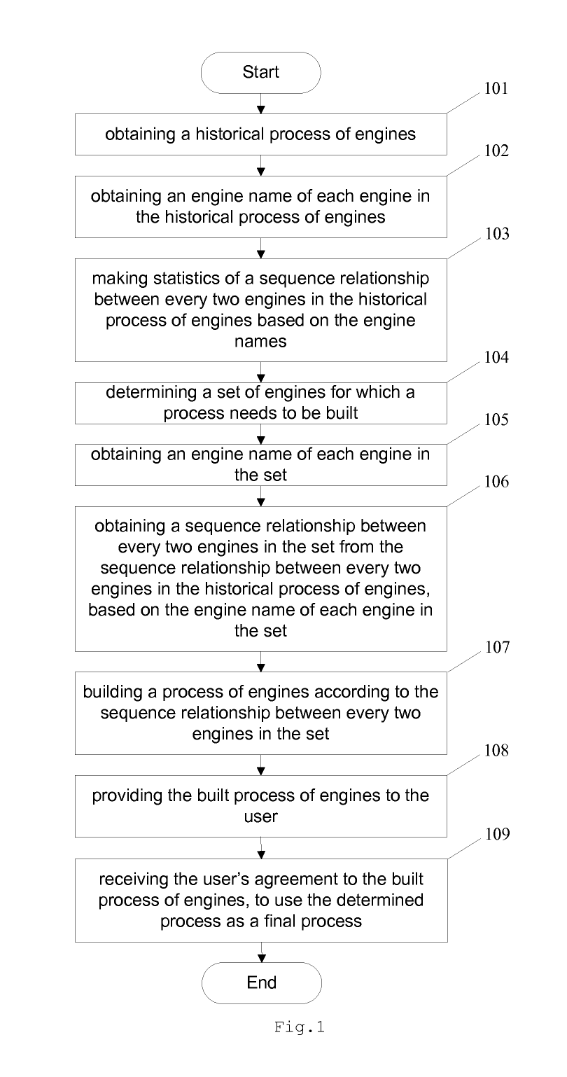

In the example of engine historical process repository as shown in Table 1, the engine historical process repository comprises two items, wherein each of the two items comprises a historical process of engines, a name of a user who once used the historical process of engines and a building time of the historical process of engines. Each item of the engine historical process repository as shown in FIG. 1 means that a certain user builds a certain process at a certain time. For example, the first item denotes that User001 builds the process “network information collecting engine→word segmentation engine” at the time 18:40:36 11-05-2008. Meanwhile, in Table 1 the historical process of engines comprises engine names and indicates the sequence between the engines.

TABLE 2
Engine Historical Process Repository

| User name | Historical process of engines | Building time |
|---|---|---|
| User001 | network information | Nov. 5, 2008 |
| | collecting engine (data reading) | 18:40:36 |
| | → word segmentation engine (data | |
| | labeling) | |
| User002 | network information | Nov. 10, 2008 |
| | collecting engine (data reading) → | 11:25:15 |
| | word segmentation engine (data | |
| | labeling) → product extraction | |
| | engine (data labeling) → company | |
| | competition analysis engine | |
| | (knowledge analysis) | |

Table 2 differs from Table 1 only in that the historical process of engines further comprises the type of each engine. For example, the first item denotes that User001 builds the process “network information collecting engine→word segmentation engine” at the time 18:40:36 Nov. 5, 2008, and further, in the process the type of the network information collecting engine is data reading and the type of word segmentation engine is data labeling.

The historical process of engines can be generated in various modes. For example, the historical process of engines can be generated by an external known device (e.g., a storage for storing a process manually built by a user) and stored in an engine historical process repository, or a valid historical process of engines can be stored in the engine historical process repository by the apparatus for building the process of engines according to the present invention. The engine types in the engine historical process repository can be either automatically labeled during generation of the historical process, or manually labeled by the user after generation of the historical process.

5. Engine Description

Engine description is details for describing an engine and can be stored in an engine description repository. In the engine description repository can be stored multiple items, each of which comprises engine-related information such as an engine name, an engine type, an engine input type, an engine output type and engine context, etc. The engine name refers to the name of an engine; the engine type refers to a functional category of the engine and for example comprises data reading, data labeling, knowledge analysis and the like; the engine input type refers to the type of data required by the engine to input; the engine output type refers to the type of data that the engine can output; the engine context refers to requirements of the engine for the preceding one engine and the engine that follows. Table 3 shows an example of the engine description repository.

TABLE 3
Engine Description Repository

| | Engine | Engine | Engine | Engine |
|---|---|---|---|---|
| Engine name | type | input type | output type | context |
| Network | Data | Web site | Web page | following |
| information | reading | | | context: word |
| collecting | | | | segmentation |
| engine | | | | engine |
| Word | Data | Web page | Word | |
| segmentation | labeling | | segmentation | |
| engine | | | labeling | |
| | | | results | |
| Product | Data | Word | Product | |
| extract | labeling | segmentation | | |
| engine | | labeling | | |
| | | results | | |
| Company | Knowledge | product | Competition | |
| competition | analysis | | analysis | |
| Analysis | | | results | |
| engine | | | | |
| Database | Data | product | Web page | |
| reading | labeling | | | |
| engine | | | | |
| Company | | | | preceding |
| extraction | | | | context: word |
| engine | | | | segmentation |
| | | | | engine |

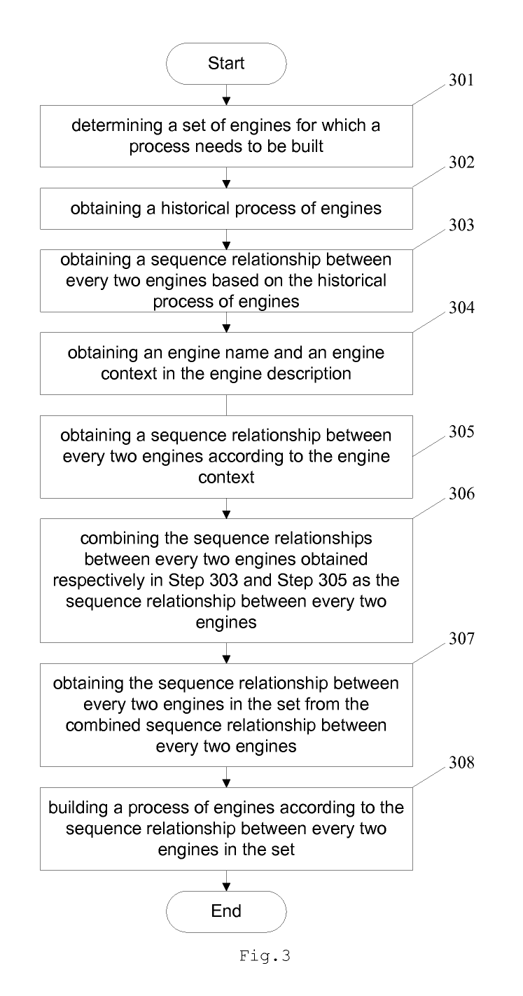

It is known from the first item of the engine description repository as shown in FIG. 3 that the network information collecting engine is a kind of data reading, the required input data type must be a web site, the output data type is a web page and the network information collecting engine can only be followed by a word segmentation engine.

The engine description repository can be generated in various modes. For example, the developer of each engine can submit engine description on his own initiative. Specifically speaking, the engine developer can manually input the engine name, the engine type, the engine input type, the engine output type and engine context, and then store such description in the engine description repository.

The present invention relates to a method for building a process of engines, which can comprise the steps of: obtaining a sequence relationship between every two engines based on a historical process of engines; and building a process of engines according to the sequence relationship between every two engines.

According to one embodiment of the present invention, the historical process of engines may comprise an engine name of each engine, and the step of obtaining the sequence relationship between every two engines based on the historical process of engines may comprise: making statistics of a sequence relationship between every two engines in the historical process of engines based on the engine name of each engine in the historical process of engines.

The step of building the process of engines according to the sequence relationship between every two engines may comprise the steps of: determining a set of engines for which a process needs to be built; obtaining an engine name of each engine in the set; obtaining a sequence relationship between every two engines in the set from the sequence relationship between every two engines, based on the engine name of each engine in the set; and building a process of engines in the set according to the sequence relationship between every two engines in the set.

According to another embodiment of the present invention, the historical process of engines may comprise an engine name and an engine type of each engine. Obtaining a sequence relationship between every two engines based on the historical process of engines may comprise: making statistics of a sequence relationship between every two engine types in the historical process of engines based on the engine name and the engine type of each engine of the historical process of engines.

The step of building the process of engines according to the sequence relationship between every two engines may comprise: determining a set of engines for which a process needs to be built; obtaining an engine name and an engine type of each engine in the set; obtaining a sequence relationship between every two engine types in the set from the sequence relationship between every two engine types of the historical process of engines, based on the engine type of each engine in the set; obtaining a sequence relationship between every two engines in the set from the sequence relationship between every two engine types in the set, based on the engine name and the engine type of each engine in the set; and building a process of engines in the set according to the sequence relationship between every two engines in the set.

According to a further embodiment of the present invention, the sequence relationship between every two engines can be obtained based on the combination of a historical process of engines and engine description. According to one example of the embodiment, a sequence relationship between every two engines can be obtained based on the historical process of engines; a sequence relationship between every two engines can be obtained based on the engine description; and the sequence relationship between every two engines obtained based on the historical process of engines and the sequence relationship between every two engines obtained based on the engine description are combined as the sequence relationship between every two engines. In the example, a set of engines for which a process needs to be built can be determined; a sequence relationship between every two engines in the set can be obtained from the combined sequence relationship between every two engines; and a process of engines in the set is built according to the sequence relationship between every two engines in the set.

According to another embodiment of the present invention, the engine description may be one of an engine name, an engine type, engine context, an engine input type, an engine output type or combination thereof.

The embodiments of the present invention are described in detail.

FIG. 1 is a flowchart showing a method for building a process of engines according to an embodiment of the present invention. In the embodiment, a sequence relationship between every two engines in a historical process of engines based on an engine name of each engine in the historical process of engines so as to build the process of engines.

In step 101, the historical process of engines is obtained.

All the items stored in the engine historical process repository can be read to obtain one or more historical processes of engines.

Alternatively, a range of the historical processes of engines which are to be read can be set based on a building time. For instance, if only historical processes of engines after the time 00:00:00 Nov. 10, 2008 are set to be acquired, the historical process of engines in the second item in Table 1 is only read. Alternatively, the range of the historical processes of engines needing read is set according to difference of users, e.g., under the circumstances that only historical processes related to user001 are set to be acquired, the historical processes in the first item in Table 1 are only read.

In the present embodiment, the historical processes of engines in the first and second items in Table 1, namely, “network information collecting engine→word segmentation engine” and “database reading engine→word segmentation engine→product extraction engine”, are read.

In Step 102, an engine name of each engine in the historical process of engines is acquired.

In the embodiment, as shown in Table 1, the historical process of engines comprises a total of four engines, namely, a network information collecting engine, a word segmentation engine, a database reading engine and a product extraction engine.

In Step 103, statistics of a sequence relationship between every two engines in the historical process of engines is carried out based on the engine names.

In the present embodiment, there are totally 4*4=16 combined sequences among the four engines. These combinations are clearly described in the historical engine transfer matrix depicted hereunder. In the matrix, each element indicates the sequence “an engine corresponding to the column where the element lies is followed by an engine corresponding to the row wherein the element lies”, and the value of the element represents an occurrence frequency of the sequence.

| | network | | | |
|---|---|---|---|---|
| | information | word | database | product |
| | collecting | segmentation | reading | extraction |
| | engine | engine | engine | engine |
| network information | 0 | 1 | 0 | 0 |
| collecting engine | | | | |
| word segmentation | 0 | 0 | 0 | 1 |
| engine | | | | |
| database reading | 0 | 1 | 0 | 0 |
| engine | | | | |
| product extraction | 0 | 0 | 0 | 0 |
| engine | | | | |

As shown above, the sequences of these engines comprises: “network information collecting engine→network information collecting engine”, “network information collecting engine→word segmentation engine”, “network information collecting engine→database reading engine”, “network information collecting engine→product extraction engine”, “word segmentation engine→network information collecting engine”, “word segmentation engine→word segmentation engine”, “word segmentation engine→database reading engine”, “word segmentation engine→product extraction engine”, “database reading engine→network information collecting engine”, “database reading engine→word segmentation engine”, “database reading engine→database reading engine”, “database reading engine→product extraction engine”, “product extraction engine→network information collecting engine”, “product extraction engine→word segmentation engine, “product extraction engine→database reading engine”, and “product extraction engine→product extraction engine”.

In Table 1, the sequence “network information collecting engine→word segmentation engine” appears once, the sequence “database reading engine→word segmentation engine” appears once, the sequence “word segmentation engine→product extraction engine” appear once, and other sequences do not appear. Therefore, in the above matrix, the value of the element in row 1 column 2 is 1 which denotes that the occurrence frequency of the sequence “network information collecting engine→word segmentation engine” in the historical process of engines is 1; the value of the element in row 2 column 4 is 1 which denotes that the occurrence frequency of the sequence “word segmentation engine→product extraction engine” in the historical process of engines is 1; the value of the element in row 3 column 2 is 1 which denotes that the occurrence frequency of the sequence “database reading engine→word segmentation engine” in the historical process of engines is 1; and, the values of other elements are zero which denotes that other sequences do not appear.

In Step 104, a set of engines for which a process needs to be built is determined.

Engines for which a process needs to be built can be determined either according to user's input or based on a pre-setting. For example, a user can input a set of engines and desires to build a process including all the engines in the set.

In Step 105, an engine name of each engine in the set is obtained.

In the present embodiment, provided the set specified by a user comprises three engines, they are respectively: a network information collecting engine, a product extraction engine and a word segmentation engine.

In Step 106, a sequence relationship between every two engines in the set is obtained from the sequence relationship between every two engines in the historical process of engines, based on the engine name of each engine in the set.

Since the set comprises three engines, there are totally 3×3=9 combined sequences among the three engines. The following user engine transfer matrix can be obtained from the sequence relationship between every two engines in the historical process of engines, for example, user engine transfer matrix can be obtained from the historical engine transfer matrix to denote the sequence relationship between every two engines in the set.

| | network | word | product |
|---|---|---|---|
| | information | segmentation | extraction |
| | collecting engine | engine | engine |
| network information | 0 | 1 | 0 |
| collecting engine | | | |
| word segmentation | 0 | 0 | 1 |
| engine | | | |
| product extraction | 0 | 0 | 0 |
| engine | | | |

Analogous to the historical engine transfer matrix, each element in the user engine transfer matrix indicates the sequence “an engine corresponding to the column where the element lies is followed by an engine corresponding to the row wherein the element lies”, and the value of the element represents an occurrence frequency of the sequence. Unlike the historical engine transfer matrix, engines associated with the user engine transfer matrix are engines in the set determined in Step 104, whereas engines associated with the historical engine transfer matrix are all the engines in the historical process of engines.

In the above user engine transfer matrix, the value of the element in row 1 column 2 is 1 which denotes that the occurrence frequency of the sequence “network information collecting engine→word segmentation engine” is 1; the value of the element in row 2 column 3 is 1 which denotes that the occurrence frequency of the sequence “word segmentation engine→product extraction engine” is 1; and the values of other elements are zero which denotes that other sequences do not appear.

In Step 107, a process of engines is built according to the sequence relationship between every two engines in the set.

In the present embodiment, since there are the two sequences “network information collecting engine→word segmentation engine” and “word segmentation engine→product extraction engine”, the process of engines “network information collecting engine→word segmentation engine→product extraction engine” is built.

In another embodiment, if the set specified by a user further comprises “data reading engine”, since the occurrence frequencies of the sequences “network information collecting engine→word segmentation engine” and “data reading engine→word segmentation engine” are both equal to 1, the following two processes can be built: “network information collecting engine→word segmentation engine→product extraction engine”, and “data reading engine→word segmentation engine→product extraction engine”.

In a further embodiment, if the set specified by a user further comprises “data reading engine” and the occurrence frequency of “network information collecting engine→word segmentation engine” is 2 and the occurrence frequency of “data reading engine→word segmentation engine” is 1, a process of engines can be built according to the occurrence frequency of the sequences. For example, the process of engines, “network information collecting engine→word segmentation engine→product extraction engine”, can be built and has a relatively high priority level, and the process of engines, “data reading engine→word segmentation engine→product extraction engine”, has a relatively low priority level. As such, the process with the relatively high priority level can be preferentially provided to the user and the process with the relatively low priority level can be provided to the user later or may be not provided to the user.

Alternatively, in Step 108, the built process of engines is provided to the user.

In the present embodiment, the process of engines, “network information collecting engine→word segmentation engine→product extraction engine”, is provided to the user.

Alternatively, in Step 109, the user's agreement to the built process of engines is received so as to use the determined process as a final process.

The user can finish evaluation of the built process according to his preference so as to determine a process. In addition, such determination can also be made according to other limitation conditions.

For example, in one embodiment of the present invention, if the set determined in Step 104 comprises “data reading engine”, the following two processes can be built: “network information collecting engine→word segmentation engine→product extraction engine”, and “data reading engine→word segmentation engine→product extraction engine” and both provided to the user. The user can select one of the processes for use as he needs.

Then the processing ends up.

Very apparently, Step 108 and Step 109 are optional, that is, in the embodiment shown in FIG. 1, Step 108 and Step 109 are not requisite. In the absence of Step 108 and Step 109, the process of engines built in Step 107 comes to an end, regardless of the number of processes built in the step. When Step 108 and Step 109 are present, they are equivalent to a user's determination step which is not requisite for the method according to the present invention.

In addition, it is appreciated that Steps 104-106 are also optional, that is, in the embodiment shown in FIG. 1, Steps 104-106 are not requisite. In the event that an engine set is not specified, a new process of engines can be built by directly using the statistical sequence relationship between every two engines in the historical process of engines.

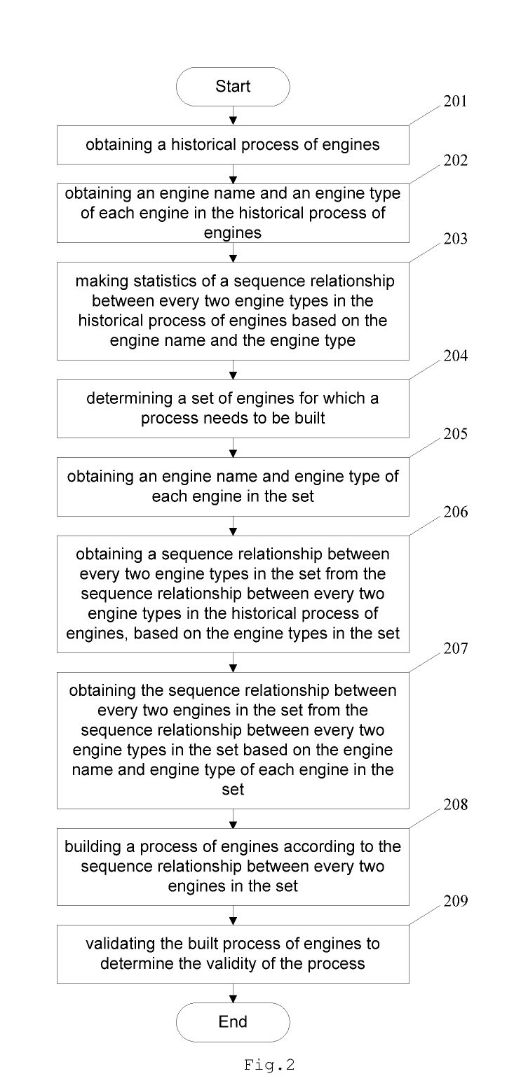

FIG. 2 is a flowchart showing a method for building a process of engines according to another embodiment of the present invention. Unlike FIG. 1, in the embodiment as shown in FIG. 2, the engine historical procedure is from the engine historical process repository shown in Table 2 and can include not only the engines forming the process but also an engine type of each engine. In the present embodiment, a sequence relationship between every two engine types in a historical process of engines based on an engine name and the engine type of each engine in the historical process of engines so as to build the process of engines.

In Step 201, the historical process of engines is obtained.

Step 201 is similar to Step 101 of FIG. 1. In the present embodiment, the engine historical process repository shown in Table 2 is used, specifically speaking, the two historical process of engines, “network information collecting engine (data reading)→word segmentation engine (data labeling)” and “network information collecting engine (data reading)→word segmentation engine (data labeling)→product extraction engine (data labeling)→company competition analysis engine (knowledge analysis)”, are used.

In Step 202, an engine name and an engine type of each engine in the historical process of engines is acquired.

The historical process of engines as shown in Table 2 comprises four engines, namely, a network information collecting engine, a word segmentation engine, a product extraction engine and a company competition analysis engine, wherein the type of the network information collecting engine is data reading, the type of word segmentation engine is data labeling, the type of the product extraction engine is also data labeling, and the type of the company competition analysis engine is knowledge analysis.

In Step 203, statistics of a sequence relationship between every two engine types in the historical process of engines is carried out based on the engine name and the engine type of each engine in the historical process of engines.

In the present embodiment, the historical process of engines comprises a total of three engine types, namely, data reading, data labeling and knowledge analysis. There are totally 3×3=9 combined sequences among the three engine types, viz., “data reading→data reading”, “data reading→data labeling”, “data reading→knowledge analysis”, “data labeling→data reading”, “data labeling→data labeling”, “data labeling→knowledge analysis”, “knowledge analysis→data reading”, “knowledge analysis→data labeling” and “knowledge analysis→knowledge analysis”. In the historical process of engines in the embodiment shown in Table 2, the sequence “network information collecting engine→word segmentation engine” appears twice, the sequence “word segmentation engine→product extraction engine” appears once, and the sequence “product extraction engine, company competition analysis engine” appears once. The two engine types corresponding to “network information collecting engine→word segmentation engine” are “data reading→data labeling”, “word segmentation engine→product extraction engine” corresponds to “data labeling→data labeling”, and “product extraction engine, company competition analysis engine” corresponds to “data labeling→knowledge analysis”. Therefore, the occurrence frequency of the sequence “data reading→data labeling” is 2, the occurrence frequency of the sequence “data labeling→data labeling” is 1, and the occurrence frequency of the sequence “data labeling, knowledge analysis” is 1, and sequences of other six engine types do not appear.

The sequence relationship between every two engines in the historical process of engines can be more clearly illustrated by using the following historical engine transfer matrix:

| | data reading | data labeling | knowledge analysis |
|---|---|---|---|
| data reading | 0 | 2 | 0 |
| data labeling | 0 | 1 | 1 |
| knowledge analysis | 0 | 0 | 0 |

In the above matrix, the value of the element in row 1 column 2 is 2 which denotes that the occurrence frequency of the sequence “data reading→data labeling” in the historical process of engines is 2; the value of the element in row 2 column 2 is 1 which denotes that the occurrence frequency of the sequence “data labeling→data labeling” in the historical process of engines is 1; the value of the element in row 2 column 3 is 1 which denotes that the occurrence frequency of the sequence “data labeling→knowledge analysis” in the historical process of engines is 1; the values of other elements are zero which denotes that other sequences do not appear in the historical process of engines.

In Step 204, a set of engines for which a process needs to be built is determined.

Engines for which a process needs to be built can be determined either according to user's input or by a pre-setting. For example, a user can input an engine set and desires to build a process including all the engines in the set.

In Step 205, an engine name and engine type of each engine in the set is obtained.

In the present embodiment, provided the set specified by a user comprises two engines, they are respectively: a word segmentation engine and a database reading engine, and the type of the word segmentation engine is data labeling and the type of the database reading engine is data reading.

In Step 206, a sequence relationship between every two engine types in the set is obtained from the sequence relationship between every two engine types in the historical process of engines obtained in Step 203, based on the engine type of each engine in the set.

In the present embodiment, the set specified by a user comprises the word segmentation engine and the database reading engine, and the type of the word segmentation engine is data labeling and the type of the database reading engine is data reading. Therefore, the engines in the determined set have two types “data labeling” and “data reading”. Since the set does not contain a company competition analysis engine, the sequence relationship related to the engine type “knowledge analysis” does not need to be considered.

In this situation, the sequence relationship between every two engine types in the set comprises the two sequences: “data reading→data labeling” and “data labeling→data labeling”, and the occurrence frequencies of the two sequences are respectively 2 and 1. Therefore, the following conclusion can be drawn: data labeling is likely to follow data labeling, and data labeling is more likely to follow the data reading.

A user engine transfer matrix can be obtained from the sequence relationship between every two engine types in the historical process of engines. The user engine transfer matrix which represents the sequence between every two engine types in the set and the occurrence frequency of the sequence, can for example be obtained from the historical engine transfer matrix. The user engine transfer matrix in the present embodiment is as follows:

| | data reading | data labeling |
|---|---|---|
| data reading | 0 | 2 |
| data labeling | 0 | 1 |

In Step 207, the sequence relationship between every two engines in the set is obtained from the sequence relationship between every two engine types in the set based on the engine name and engine type of each engine in the set.

In the present embodiment, since the engine set specified by a user only comprises two engines: word segmentation engine (with an engine type data labeling) and database reading engine (with an engine type data reading), and since the sequence relationship between every two engine types in the set comprises the two sequences: “data reading→data labeling” and “data labeling→data labeling”, the sequence relationship between every two engines in the set can include the two sequences: “database reading engine→word segmentation engine” and “word segmentation engine→word segmentation engine”. Besides, since the occurrence frequencies of the two sequences “data reading→data labeling” and “data labeling→data labeling” are respectively 2 and 1, the occurrence frequencies of “database reading engine→word segmentation engine” and “word segmentation engine→word segmentation engine” are considered to be 2 and 1 accordingly.

In Step 208, a process of engines is built according to the sequence relationship between every two engines in the set.

In the present embodiment, since the engine set specified by a user comprises one word segmentation engine, the process “database reading engine→word segmentation engine” is built.

In another embodiment, since the occurrence frequencies of the sequences “data reading→data labeling” and “data labeling→data labeling” are respectively 2 and 1, the sequence with a maximum occurrence frequency, namely, the sequence “data reading→data labeling” can be selected to build a process of engines. Specifically speaking, “database reading engine→word segmentation engine” corresponding to “data reading→data labeling” can be used to build the process of engines.

In Step 209, alternatively, the built process of engines is validated to determine the validity of the process.

In the present invention, validity of the process can be determined by static validation, dynamic validation or the combination thereof.

In static validation, an engine description repository is first searched to obtain an input type and an output type of each engine in the process, and then whether the output type of the previous one engine of each pair of adjacent engines in the process is consistent with the input type of the latter engine is inspected. In the event of consistency, the static validation is successful.

In dynamic validation, first the process is run to check whether the values of practical input and output of each engine in the process are both not empty. If they both are not empty, the dynamic validation is successful.

It can be predetermined that only when the static validation is successful, the process of engines is a valid process; or, it can be predetermined that only when the dynamic validation is successful, the process of engines is a valid process; or, it can be predetermined that only when both the static validation and the dynamic validation are successful, the process of engines is a valid process. For example, with regard to the process “network information collecting engine→word segmentation engine→product tagging engine”, since the output type of the network information collecting engine and the input type of the word segmentation engine are both “web page” and the output type of the word segmentation engine and the input type of the product extraction engine are both “word segmentation labeling result”, the static validation of the process is successful; then the process is run after setting an actual web site (e.g., www.nec.com) for the input of the network information collecting engine to determine whether the input value or the output value of each engine is empty, and if not, the dynamic validation is successful; in this way, the process can be determined as a valid process.

In the present embodiment, in Step 209, what is validated is the process “database reading engine→word segmentation engine”. Since the output type of the database reading engine and the input type of the word segmentation are both “web page”, the static validation of the process is successful; then the process is run after setting a product name for the input of the database reading engine and the input and output values of the engine are both not empty, so the dynamic validation of the process is successful. As such, the process “database reading engine→word segmentation engine” in the present embodiment can be determined valid.

Then the processing ends up.

Very apparently, Step 209 is optional, that is, in the embodiment shown in FIG. 2, Step 209 is not requisite. In the event of no validation, the process of engines built in Step 208 can be considered as a final result.

In addition, it is appreciated that Steps 204-206 are also optional, that is, in the embodiment shown in FIG. 2, Steps 204-206 are not requisite. In the event that an engine set is not specified, the sequence relationship between every two engines in the historical process of engines can be obtained and thereby the process of engines can be built by directly using the sequence relationship between every two engine types in the historical process of engines, and the engine name and engine type of each engine included in the historical process of engines.

Besides, it is noticeable that the embodiment shown in FIG. 2 can also include Step 108 and Step 109 in the process shown in FIG. 1. The embodiment shown in FIG. 1 can also include Step 209 of the process as shown in FIG. 2.

According to the method of the embodiment of the present invention, the process of engines can also be built according to both the historical process of engines and the engine description. FIG. 3 is a flowchart showing a method for building a process of engines according to a further embodiment of the present invention and shows an embodiment of building the process of engines based on both the engine historical engine and the engine description. Specifically speaking, in the embodiment shown in FIG. 3 the engine name and the engine context in the engine description are used. In this embodiment, firstly a sequence relationship between every two engines is obtained based on the historical process of engines and a sequence relationship between every two engines is obtained based on the engine description; then the combination of the sequence relationship between every two engines obtained based on the historical process of engines and the sequence relationship between every two engines obtained based on the engine description is used as a sequence relationship between every two engines to build the process of engines. The embodiment is described in detail as follows:

In Step 301, a set of engines for which a process needs to be built is determined.

Step 301 is similar to Step 104 of FIG. 1. Engines for which a process needs to be built can be determined either according to user's input or by a pre-setting. In this embodiment, a user inputs an engine set including three engines: word segmentation engine, network information collecting engine and a company extraction engine.

In Step 302, the historical process of engines is obtained.

Step 302 is similar to Step 101 of FIG. 1. In this embodiment, provided that the historical process of engines comprises the two processes “network information collecting engine→word segmentation engine” and “network information collecting engine→word segmentation engine→product extraction engine→company competition analysis engine”.

In Step 303, a sequence relationship between every two engines is obtained based on the historical process of engines.

In the present embodiment, the sequence between every two engines obtained based on the historical process comprises: “network information collecting engine→word segmentation engine”, “word segmentation engine→product extraction engine” and “product extraction engine→company competition analysis engine”.

In Step 304, an engine name and an engine context in the engine description is obtained.

The engine context can be obtained according to the engine description shown in Table 3, wherein the following context of the network information collecting engine is word segmentation engine and the preceding context of the company extraction engine is word segmentation engine.

In Step 305, a sequence relationship between every two engines is obtained according to the engine context.

According to the engine context shown in Table 3, the sequence relationship between every two engines comprises the two sequences “network information collecting engine→word segmentation engine” and “word segmentation engine→company extraction engine”, and the occurrence frequencies of the two sequences are respectively 1.

It is noticeable that the sequence between Steps 302-303 and Steps 304-305 is interchangeable. That is to say, in another embodiment, after Step 301 is executed, Steps 304-305 are first executed, and then Steps 302-303 are executed, which do not affect the fulfillment of the method of the present invention.

In Step 306, the sequence relationships between every two engines obtained respectively in Step 303 and Step 305 are combined as the sequence relationship between every two engines.

In the present embodiment, the sequence relationship between every two engines obtained in Step 303 is: “network information collecting engine→word segmentation engine”, “word segmentation engine→product extraction engine” and “product extraction engine→company competition analysis engine”. The sequence relationship between every two engines obtained in Step 305 is: “network information collecting engine→word segmentation engine” and “word segmentation engine→company extraction engine”. The sequence relationship between every two engines obtained by combining the above two sequence relationships can include: “network information collecting engine→word segmentation engine”, “word segmentation engine→product extraction engine”, “product extraction engine→company competition analysis engine” and “word segmentation engine→company extraction engine”.

In Step 307, the sequence relationship between every two engines in the set is obtained from the combined sequence relationship between every two engines obtained in Step 306.

Since the set determined in Step 301 comprises word segmentation engine, network information collecting engine and company extraction engine. Therefore, the sequence relation of any two of the three engines needs to be found from the combined sequence relationship between every two engines obtained in Step 306.

In the present embodiment, from theses sequence relations “network information collecting engine→word segmentation engine”, “word segmentation engine→product extraction engine”, “product extraction engine→company competition analysis engine” and “word segmentation engine→company extraction engine” can be obtained the sequence relationship between every two engines in the set, which comprises “network information collecting engine→word segmentation engine” and “word segmentation engine→company extraction engine”.

In Step 308, a process of engines is built according to the sequence relationship between every two engines in the set.

The process of engines “network information collecting engine→word segmentation engine→company extraction engine” can be obtained according to the sequence relationship between every two engines in the set obtained in Step 307, i.e., “network information collecting engine→word segmentation engine” and “word segmentation engine→company extraction engine”.

Then the processing ends up.

It is appreciated that Steps 301-307 are optional. Without Steps 301 and Step 307, i.e., an engine set is not set, the process of engines is built in Step 308 by using the sequence relationship between every two engines obtained in Step 306. Therefore, absence of Step 301 and Step 307 does not affect implementation of the method of the present invention. Besides, Step 301 can be performed in any step before Step 307.

In addition, noticeably, the embodiment shown in FIG. 3 can include Steps 108 and Step 109 in the process shown in FIG. 1. The embodiment shown in FIG. 3 can include Step 209 in the process shown in FIG. 2.

In an variation of the embodiment shown in FIG. 3, the engine name, engine input type and engine output type in the engine description rather than the engine context are obtained in Step 304; in Step 305 the sequence relationship between every two engines is obtained according to the engine input type and the engine output type; in Step 306, the sequence relationship between every two engines obtained based on the historical process and the sequence relationship between every two engines obtained based on the engine input type and the engine output type can be considered as the sequence relationship between every two engines.

In another embodiment of the present invention, with regard to the historical process of engines not including an engine type, a corresponding engine type can be searched from the engine description repository according to the engine name to determine each engine type in the historical process of engines. Then processing can be conducted by using the method of the present invention, for example, the process of engines can be built by executing Steps 203-208 in FIG. 2.

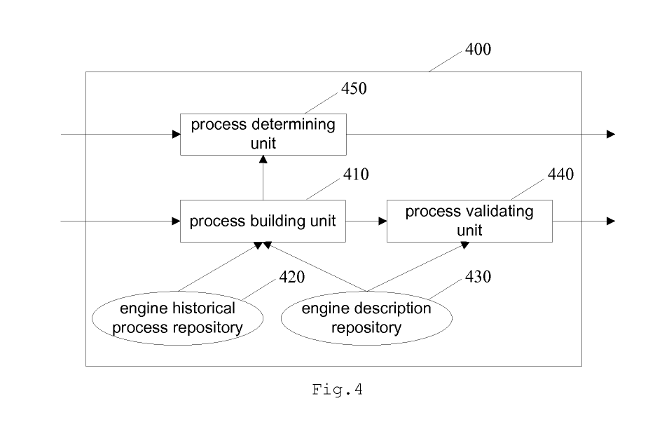

FIG. 4 is a block diagram of an apparatus 400 for building a process of engines according to an embodiment of the present invention.

The apparatus 400 can comprise a process building unit 410 which may comprise: means for obtaining a sequence relationship between every two engines based on a historical process of engines; and means for building a process of engines according to the sequence relationship between every two engines.

The apparatus 400 can further comprise: a historical process of engines repository 420 for storing the historical process of engines. The process building unit 410 can obtain the historical process of engines from the engine historical process repository 420.

The apparatus 400 can further comprise an engine description repository 430 for storing engine description and can comprises engine description including an engine name, an engine type, engine context, an engine input type, an engine output type or the like.

Additionally, the apparatus 400 can further comprise a process determining unit 440 and a process validating unit 450. The process determining unit 440 can comprise: means for providing the built process of engines to a user; and means for receiving the user's determination as to the built process of engines, to use the determined process as a final process. The process validating unit 450 is used to determine validity of the process. Specifically speaking, the process validating unit 450 can comprise means for subjecting the built process of engines to a static validation, a dynamic validation or a combination thereof.

In one embodiment, the historical process of engines comprises an engine name of each engine, and the means which is comprised in the process building unit 410 for obtaining a sequence relationship between every two engines based on the historical process of engines can comprise: means for obtaining an engine name of each engine of the historical process of engines; and means for making statistics of a sequence relationship between every two engines in the historical process of engines based on the engine name.

The means which is comprised in the process building unit 410 for building the process of engines according to the sequence relationship between every two engines can comprise: means for determining a set of engines for which a process needs to be built; means for obtaining an engine name of each engine in the set; means for obtaining a sequence relationship between every two engines in the set from the sequence relationship between every two engines, based on the engine name of each engine in the set; and means for building a process of engines in the set according to the sequence relationship between every two engines in the set.

In another embodiment, the historical process of engines comprises an engine name and an engine type of each engine, and the means which is comprised in the process building unit 410 for obtaining the sequence relationship between every two engines based on the historical process of engines can comprise: means for obtaining an engine name and an engine type of each engine of the historical process of engines; and means for making statistics of a sequence relationship between every two engine types in the historical process of engines based on the engine name and the engine type.

The means which is comprised in the process building unit 410 for building the process of engines according to the sequence relationship between every two engines can comprise: means for determining a set of engines for which a process needs to be built; means for obtaining an engine name and an engine type of each engine in the set; means for obtaining a sequence relationship between every two engine types in the set from the sequence relationship between every two engine types of the historical process of engines, based on the engine type of each engine in the set; means for obtaining a sequence relationship between every two engines in the set from the sequence relationship between every two engine types in the set, based on the engine name and the engine type of each engine in the set; and means for building a process of engines in the set according to the sequence relationship between every two engines in the set.

In another embodiment, the process building unit 410 can further comprise: means for obtaining a sequence relationship between every two engines based on a historical process of engines and engine description. The means for obtaining the sequence relationship between every two engines based on the historical process of engines and engine description can comprise: means for obtaining a sequence relationship between every two engines based on the historical process of engines; means for obtaining a sequence relationship between every two engines based on the engine description; and means for combining the sequence relationship between every two engines obtained based on the historical process of engines and the sequence relationship between every two engines obtained based on the engine description as the sequence relationship between every two engines.

Alternatively, the means which is comprised in the process building unit 410 for building the process of engines according to the sequence relationship can comprise: means for determining a set of engines for which a process needs to be built; means for obtaining a sequence relationship between every two engines in the set from the combined sequence relationship between every two engines; and means for building a process of engines in the set according to the sequence relationship between every two engines in the set.

Alternatively, the means for determining a set of engines for which a process needs to be built can be executed according to the user's input or presetting.

The present invention further relates to a computer program product comprising codes for executing the following: obtaining a sequence relationship between every two engines based on a historical process of engines; and building a process of engines according to the sequence relationship between every two engines. Before use, the codes can be stored in a memory of other computer systems, for example, stored in a hard disk or a moveable memory such as CD or a floppy disk, or downloaded via Internet or other computer networks.

The method of the present invention as disclosed can be fulfilled in software, hardware, or a combination thereof. The hardware portion can be achieved by using special logic; software portion can be stored in the memory and executed by an appropriate instruction executing system such as a microprocessor, a personal computer (PC), or a mainframe computer.

Noticeably, to make the present invention more comprehensible, the above description omits some more concrete technical details which are publicly known for those skilled in the art and might be requisite for the fulfillment of the present invention.

The description of the present invention is furnished herein for illustration and depiction purpose not to list all the embodiments or limit the present invention to the forms as disclosed above. Many modifications and alterations are all obvious for those having ordinary skill in the art.

Therefore, selection and depiction of the above embodiments aim to better explain the principles and practical application of the present invention and make those having ordinary skill in the art to understand that without departure from the essence of the present invention, all modifications and alterations fall into the scope of protection of the present invention as defined by the following appended claims.

What is claimed is:

1. A method for building a process of engines, comprising:
obtaining a sequence relationship between every two engines based on a historical process of engines; and
building a process of engines according to the sequence relationship between every two engines.

2. The method according to claim 1, wherein the historical process of engines comprises an engine name of each engine, and obtaining a sequence relationship between every two engines based on a historical process of engines comprises:
obtaining an engine name of each engine of the historical process of engines; and
making statistics of a sequence relationship between every two engines in the historical process of engines based on the engine name.

3. The method according to claim 2, wherein building a process of engines according to the sequence relationship between every two engines comprises:
determining a set of engines for which a process needs to be built;
obtaining an engine name of each engine in the set;
obtaining a sequence relationship between every two engines in the set from the sequence relationship between every two engines, based on the engine name of each engine in the set; and
building a process of engines in the set according to the sequence relationship between every two engines in the set.

4. The method according to claim 1, wherein the historical process of engines comprises an engine name and an engine type of each engine, and obtaining a sequence relationship between every two engines based on a historical process of engines comprises:
obtaining an engine name and an engine type of each engine of the historical process of engines; and
making statistics of a sequence relationship between every two engine types in the historical process of engines based on the engine name and the engine type.

5. The method according to claim 4, wherein building a process of engines according to the sequence relationship between every two engines comprises:
determining a set of engines for which a process needs to be built;
obtaining an engine name and an engine type of each engine in the set;
obtaining a sequence relationship between every two engine types in the set from the sequence relationship between every two engine types of the historical process of engines, based on the engine type of each engine in the set;
obtaining a sequence relationship between every two engines in the set from the sequence relationship between every two engine types in the set, based on the engine name and the engine type of each engine in the set; and
building a process of engines in the set according to the sequence relationship between every two engines in the set.

6. The method according to claim 1, further comprising:
obtaining a sequence relationship between every two engines based on a historical process of engines and engine description.

7. The method according to claim 6, wherein obtaining a sequence relationship between every two engines based on a historical process of engines and engine description comprises:
obtaining a sequence relationship between every two engines based on the historical process of engines;
obtaining a sequence relationship between every two engines based on the engine description; and
combining the sequence relationship between every two engines obtained based on the historical process of engines and the sequence relationship between every two engines obtained based on the engine description into the sequence relationship between every two engines.

8. The method according to claim 7, wherein building a process of engines according to the sequence relationship between every two engines comprises:
determining a set of engines for which a process needs to be built;
obtaining a sequence relationship between every two engines in the set from the combined sequence relationship between every two engines; and
building a process of engines in the set according to the sequence relationship between every two engines in the set.

9. The method according to any one of claims 6 to 8, wherein the engine description comprises at least one of an engine name, an engine type, engine context, an engine input type, and an engine output type.

10. The method according to claim 1, further comprising:
providing the built process of engines to a user; and
receiving the user's determination as to the built process of engines, to use the determined process as a final process.

11. The method according to claim 1, further comprising:
subjecting the built process of engines to a static validation, a dynamic validation or a combination thereof.

12. An apparatus for building a process of engines, comprising:
a process building unit, comprising:
means for obtaining a sequence relationship between every two engines based on a historical process of engines; and
means for building a process of engines according to the sequence relationship between every two engines.

13. The apparatus according to claim 12, wherein the historical process of engines comprises an engine name of each engine, and the means for obtaining a sequence relationship between every two engines based on a historical process of engines comprises:
means for obtaining an engine name of each engine of the historical process of engines; and
means for making statistics of a sequence relationship between every two engines in the historical process of engines based on the engine name.

14. The apparatus according to claim 13, wherein the means for building a process of engines according to the sequence relationship between every two engines comprises:
means for determining a set of engines for which a process needs to be built;
means for obtaining an engine name of each engine in the set;
means for obtaining a sequence relationship between every two engines in the set from the sequence relationship between every two engines, based on the engine name of each engine in the set; and
means for building a process of engines in the set according to the sequence relationship between every two engines in the set.

15. The apparatus according to claim 12, wherein the historical process of engines comprises an engine name and an engine type of each engine, and the means for obtaining a sequence relationship between every two engines based on a historical process of engines comprises:
means for obtaining an engine name and an engine type of each engine of the historical process of engines; and
means for making statistics of a sequence relationship between every two engine types in the historical process of engines based on the engine name and the engine type.

16. The apparatus according to claim 15, wherein the means for building a process of engines according to the sequence relationship between every two engines comprises:
means for determining a set of engines for which a process needs to be built;
means for obtaining an engine name and an engine type of each engine in the set;
means for obtaining a sequence relationship between every two engine types in the set from the sequence relationship between every two engine types of the historical process of engines, based on the engine type of each engine in the set;
means for obtaining a sequence relationship between every two engines in the set from the sequence relationship between every two engine types in the set, based on the engine name and the engine type of each engine in the set; and
means for building a process of engines in the set according to the sequence relationship between every two engines in the set.

17. The apparatus according to claim 12, wherein the process building unit further comprises:
means for obtaining a sequence relationship between every two engines based on a historical process of engines and engine description.

18. The apparatus according to claim 17, wherein the means for obtaining a sequence relationship between every two engines based on a historical process of engines and engine description comprises:
means for obtaining a sequence relationship between every two engines based on the historical process of engines;
means for obtaining a sequence relationship between every two engines based on the engine description; and
means for combining the sequence relationship between every two engines obtained based on the historical process of engines and the sequence relationship between every two engines obtained based on the engine description into the sequence relationship between every two engines.

19. The apparatus according to claim 18, wherein the means for building a process of engines according to the sequence relationship between every two engines comprises:
means for determining a set of engines for which a process needs to be built;
means for obtaining a sequence relationship between every two engines in the set from the combined sequence relationship between every two engines; and
means for building a process of engines in the set according to the sequence relationship between every two engines in the set.

20. The apparatus according to claim 12, further comprising:
a historical process of engines repository for storing a historical process of engines.

21. The apparatus according to claim 12, further comprising:
an engine description repository for storing engine description, the engine description comprising at least one of an engine name, an engine type, engine context, an engine input type, and an engine output type.

22. The apparatus according to claim 12, further comprising a process determination unit, the process determination unit comprising:
means for providing the built process of engines to a user; and
means for receiving the user's determination as to the built process of engines, to use the determined process as a final process.

23. The apparatus according to claim 12, further comprising a process validation unit for subjecting the built process of engines to a static validation, a dynamic validation or a combination thereof.
